(19) United States
(12) Patent Application Publication
(10) Pub. No.: US 2026/0220910 A1
(43) Pub. Date: Jul. 30, 2026

(54) TRANSFORMER-BASED LINE SEGMENT MATCHING ACROSS IMAGES

(71) Applicant: Cognex Corporation, Natick, MA (US)

(72) Inventors: Mo Chen, Natick, MA (US); Lowell D. Jacobson, Grafton, MA (US); Lei Wang, Wayland, MA (US)

(21) Appl. No.: 19/462,666

(22) Filed: Jan. 28, 2026

Related U.S. Application Data
(60) Provisional application No. 63/750,411, filed on Jan. 28, 2025.
(60) Provisional application No. 63/946,421, filed on Dec. 22, 2025.

(51) Int. Cl. G06V 10/75; G06V 10/77; G06V 10/82

(52) U.S. Cl. CPC G06V 10/752; G06V 10/7715; G06V 10/82

(57) ABSTRACT

A system for matching line segments between images includes a transformer-based neural network with an encoder processing input images and a decoder processing a query line segment from a first image. A parallel decoding module estimates corresponding line segments in a second image based on processed feature maps and query line segments from the first image. The system may include a recursive zoom-in module that iteratively refines the estimated corresponding line segments by zooming into regions around initial estimates to achieve sub-pixel accuracy. The transformer-based neural network can be trained using a data generation process that adapts based on training loss curves.

### CROSS-REFERENCE TO RELATED APPLICATIONS

This application claims the priority of U.S. Provisional Application 63/750,411 filed on Jan. 28, 2025. This application claims the benefit of U.S. Provisional Application 63/946,421 filed on Dec. 22, 2025. The entire contents of these applications are incorporated herein by reference in their entirety.

### TECHNICAL FIELD

The present disclosure relates to computer vision and image processing, and more particularly to a transformer-based system and method for matching line segments across images with sub-pixel accuracy.

### BACKGROUND

Line segment matching across images is a fundamental task in computer vision with applications ranging from camera calibration to visual localization, gauging and measurement, object tracking, and pose estimation. Traditional approaches to this problem typically follow a “detect-describe-match” pipeline. These methods first detect line segments in both images, then compute descriptors for the detected lines, and finally match the lines based on descriptor similarity. More recently, deep learning techniques have been applied to various stages of the line matching pipeline. Convolutional neural networks have been used to improve line segment detection, while learned descriptors aim to provide more robust representations of line segments and their surrounding image context. Graph neural networks and attention mechanisms have also been explored to incorporate global scene information and geometric constraints into the matching process. However, these learned approaches still largely adhere to the multi-stage pipeline paradigm, which can limit their ability to reason about correspondences in a holistic manner.

Traditional methods of shape matching mostly rely on comparing similarities and distances between the template and candidate image patch, using approaches such as sum of squared differences (SSD), normalized cross-correlation (NCC), sum of absolute differences (SAD), and gradient-based measures. Such approaches may degrade significantly in the presence of cluttered backgrounds, image blurring, or large deformations. Deep learning-based methods have significantly improved feature representation, but these approaches can struggle with textureless regions, repetitive patterns, and large changes in viewpoint or imaging conditions. Even with deep-learning-based local patch descriptors, the matching is still performed by variants of nearest neighbor assignment in a feature space, optionally followed by separate disambiguation stages based on geometric constraints.

### SUMMARY

Transformer architectures, originally developed for natural language processing tasks, have recently shown promise when applied to computer vision problems. By encoding relationships between all elements of the input data, transformers can capture both local and global context. This property makes them well-suited for correspondence problems, where understanding the overall scene structure is often crucial. However, the application of transformers to the specific task of line segment matching across images remains largely unexplored.

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

In a first aspect, the technology provides a system for matching geometric shapes between images. The system comprises a convolutional neural network that extracts feature maps from a reference image and a test image. The system comprises a transformer encoder that processes the feature maps from the reference image and the test image to generate encoded features. The system comprises a transformer decoder comprising a masked multi-head self-attention mechanism that processes a query shape represented as a sequence of ordered points from the reference image, wherein the masked multi-head self-attention mechanism models interrelationships between the ordered points on the query shape. The system comprises a multilayer perceptron that generates corresponding shape points in the test image based on output from the transformer decoder.

In some embodiments, the query shape comprises a sequence of N ordered point locations represented as coordinate pairs (x₀, y₀), (x₁, y₁), . . . , (xₙ_{⁻¹}, yₙ_{⁻¹}) in the reference image. In some embodiments, the ordered points are evenly distributed along the geometrical shape. In other embodiments, the ordered points are distributed along a contour of the query shape with more points positioned around edge points having high curvatures and fewer points positioned on straight line segments. In yet other embodiments, the transformer decoder processes the sequence of ordered points in a causal manner such that decoding of point pᵢ depends on decoding outputs of all previously decoded points p₀ through pᵢ_{⁻¹}. In some embodiments, the system further comprises a coarse-to-fine correspondence refinement module that estimates an initial homography using coarse correspondences from the transformer decoder, warps corresponding local patches from the reference image and the test image based on the initial homography, and applies the transformer encoder and transformer decoder to the warped patches to obtain refined shape correspondence. In other embodiments, the coarse-to-fine correspondence refinement module iteratively applies the refinement process multiple times to achieve sub-pixel accuracy. In yet other embodiments, the query shape comprises one of an open contour, a closed contour, a concave boundary, a convex boundary, an object edge, or an edge-invisible shape located in a uniform, textureless region.

In a second aspect, the technology provides a method for matching geometric shapes between images. The method comprises extracting feature maps from a reference image and a test image using a convolutional neural network. The method comprises processing the feature maps using a transformer encoder to generate encoded features. The method comprises processing a query shape represented as a sequence of ordered points from the reference image using a transformer decoder comprising a masked multi-head self-attention mechanism, wherein the masked multi-head self-attention mechanism captures causal dependencies between sequential points along a shape contour. The method comprises generating corresponding shape points in the test image using a multilayer perceptron based on output from the transformer decoder.

In some embodiments, the query shape comprises a sequence of N ordered point locations represented as coordinate pairs (x₀, y₀), (x₁, y₁), . . . , (xₙ_{⁻¹}, yₙ_{⁻¹}) in the reference image. In other embodiments, the ordered points are distributed along a contour of the query shape with more points positioned around edge points having high curvatures and fewer points positioned on straight line segments. In yet other embodiments, the transformer decoder processes the sequence of ordered points in a causal manner such that decoding of point pᵢ depends on decoding outputs of all previously decoded points p₀ through pᵢ_{⁻¹}. In some embodiments, the method further comprises a step of performing coarse-to-fine correspondence refinement by estimating an initial homography using coarse correspondences from the transformer decoder, warping corresponding local patches from the reference image and the test image based on the initial homography, and applying the transformer encoder and transformer decoder to the warped patches to obtain refined shape correspondence. In other embodiments, the method further comprises a step of iteratively applying the coarse-to-fine correspondence refinement process multiple times to achieve sub-pixel accuracy. In yet other embodiments, the query shape comprises one of an open contour, a closed contour, a concave boundary, a convex boundary, an object edge, or a shape located in a uniform textureless region.

In a third aspect, the technology provides a computer-implemented method for achieving sub-pixel accuracy in shape correspondence between images. The method comprises obtaining an initial coarse estimate of a corresponding shape in a test image for a query shape in a reference image using a transformer-based neural network comprising a transformer decoder with masked multi-head self-attention. The method comprises estimating an initial homography using the coarse estimate. The method comprises warping corresponding local patches from the reference image and test image based on the initial homography. The method comprises applying the transformer-based neural network to the warped patches to obtain a refined shape correspondence with sub-pixel accuracy.

In some embodiments, the query shape comprises a sequence of N ordered point locations represented as coordinate pairs (x₀, y₀), (x₁, y₁), . . . , (xₙ_{⁻¹}, yₙ_{⁻¹}) in the reference image. In other embodiments, the ordered points are distributed along a contour of the query shape with more points positioned around edge points having high curvatures and fewer points positioned on straight line segments. In yet other embodiments, the step of applying the transformer-based neural network to the warped patches is performed iteratively multiple times to progressively improve the refined shape correspondence. In some embodiments, the iterative application continues until a predetermined accuracy threshold of less than one pixel is achieved. In other embodiments, the query shape comprises one of an open contour, a closed contour, a concave boundary, a convex boundary, an object edge, or a shape located in a uniform textureless region.

The foregoing general description of the illustrative embodiments and the following detailed description thereof are merely exemplary aspects of the teachings of this disclosure and are not restrictive.

### BRIEF DESCRIPTION OF FIGURES

Non-limiting and non-exhaustive examples are described with reference to the following figures.

FIG. 1 illustrates a block diagram of a line matching system for matching line segments between images, according to aspects of the present disclosure.

FIG. 2 illustrates a flowchart of a method for achieving sub-pixel accuracy in line segment matching between images, according to aspects of the present disclosure.

FIG. 3 illustrates a flowchart of a method for training a line segment matching model, according to aspects of the present disclosure.

### DETAILED DESCRIPTION

The following description sets forth exemplary aspects of the present disclosure. It should be recognized, however, that such description is not intended as a limitation on the scope of the present disclosure. Rather, the description also encompasses combinations and modifications to those exemplary aspects described herein.

The present disclosure provides a system and methods for matching line segments between images using a transformer-based neural network. This system leverages the global and local context encoding capabilities of transformers to directly match line segments across images, given a query line segment in a reference image and a test image. The transformer-based neural network includes an encoder for processing feature maps of the input images and a decoder for processing the query line segment. The system also includes a parallel decoding module that estimates corresponding line segments in the test image based on the processed feature maps and query line segment.

In some embodiments, the system 100 may process input images according to specific dimensional requirements to enable efficient transformer processing. The input images may be cropped and resized to 3×256×256 pixels before being fed into the pretrained convolutional neural network backbone, such as ResNet50 106. The convolutional neural network backbone 106 may convert each input image into a ⅛ downsampled feature map of size 1024×32×32, where 1024 represents the number of feature channels (output channels from ResNet50 at Layer 3) and 32×32 represents the spatial dimensions of the feature map. In another embodiment, the convolutional neural network backbone 106 may convert each input image into a downsampled feature map of size 1024×32×32, where 1024 represents the number of feature channels and 32×32 represents the spatial dimensions of the feature map. In yet another embodiment, the convolutional neural network backbone 106 may further reduced into channel feature map 256×32×32, where 256 represents the number of feature channels and 32×32 represents the spatial dimensions of the feature map. Other choices of CNNs backbone and downsampling configurations may also be employed depending on the specific application requirements, computational constraints, and desired trade-offs between spatial resolution and feature channel depth.

In some cases, the feature maps extracted from the first image 102 and the second image 104 may be concatenated side by side to form a combined context feature map. The concatenation may result in a context feature map of size 256×32×64, where the spatial dimension has been doubled in one direction to accommodate features from both images. In another embodiment, the concatenation may result in a context feature map of size 256×32×64, where 256 represents the number of feature channels and 32×64 represents the spatial dimensions of the combined feature map. Positional encoding with respect to the spatial resolution 32×64 may be added to the context feature map to provide spatial awareness to the transformer encoder 108. The positional encoding may enable the transformer to distinguish between different spatial locations in the feature maps and understand the geometric relationships between features.

The feature map 256×32×64 is flattened into a 1D vector as 256×2048 to the encoder. The encoder is a 6 sequential vision transformer block with a hidden dimension of 256. The output of the encoder is the 256×2048 enhanced features contain information from both images. The decoder comprises 6 standard transformer decoder blocks that take the encoded features and the encoded query-shape information describing the first shape in the first image.
The number of blocks in the vision transform encoder and decoder, and the hidden dimension are employed depending on the specific application requirements, computational constraints, and desired accuracy. In addition, the transform encoder and decoder can also be the pretrained ones to exploit the knowledge gained from the other domains.

In some embodiments, the system 100 may operate in an end-to-end manner without requiring preprocessing or postprocessing steps. The system 100 may require only the raw images of the first image 102 and second image 104, along with the query line segment or shape annotation from the first image 102. The floating-point coordinates of the matched shape in the second image 104 may be the direct output of the multilayer perceptron 112, without requiring additional processing steps such as RANSAC-based outlier rejection, geometric verification, or descriptor matching. This end-to-end processing may simplify the deployment and operation of the system 100 while reducing computational overhead and potential sources of error associated with multi-stage pipelines.

In some embodiments, the transformer-based neural network may include a convolutional neural network backbone for extracting features from the input images. The convolutional neural network backbone may be a pretrained vision transformer, providing a robust and efficient feature extraction mechanism. In particular, vision transformers provide several advantages, including: leveraging knowledge gained from training on large-scale datasets, allowing pretrained vision transformers to capture general visual features that can be applied to various tasks; using self-attention to model long-range dependencies in images, enabling vision transformers to capture global context more effectively than traditional convolutional neural networks; handling variable input sizes with strong performance on both small and large datasets; a pretrained vision transformers can be fine-tuned on smaller datasets with good results, reducing the need for large amounts of task-specific training data; and the ability to be easily adapted to handle multiple modalities, such as combining image and text data. The extracted features from the convolutional neural network backbone 106 are then processed by the transformer encoder 108.

In some embodiments, the use of vision transformers in the system 100 may provide several advantages over traditional convolutional neural networks. Vision transformers may operate as global operations that can model relationships between all locations in the images, whereas convolutions are local operations that typically model only relationships between neighboring pixels. In the transformer architecture, all tokens (which may represent projections of non-overlapping image patches into one-dimensional vectors) may be embedded with position information, making the tokens aware of distances between each other. This global relationship modeling may make transformers a natural fit for correspondence problems where understanding the overall scene structure is important. In contrast, dense features extracted by convolutional neural networks may have limited receptive fields, which may not distinguish indistinctive regions or capture long-range dependencies effectively.

In some embodiments, the transformer-based neural network may comprise pretrained end-to-end vision transformers that have been trained on large-scale datasets before being adapted for the shape matching task. The pretrained vision transformers may provide a robust foundation for feature extraction and correspondence estimation, leveraging knowledge gained from training on diverse visual data. The end-to-end nature of the pretrained transformers may enable the system 100 to directly map from input images and query shapes to output correspondences without requiring intermediate representations or multi-stage processing.

In some embodiments, the transformer encoder 108 may employ bidirectional self-attention mechanisms to process the concatenated feature maps from both images. The bidirectional self-attention may allow each location in the feature maps to attend to all other locations, including both preceding and following positions in the spatial arrangement. This bidirectional processing may enable the transformer encoder 108 to consolidate and enhance the feature representations from both the first image 102 and the second image 104, capturing relationships between corresponding regions across the images and building a rich contextual representation that facilitates subsequent correspondence estimation by the transformer decoder 110.

In some embodiments, the transformer decoder 110 may include a masked multi-head self-attention mechanism that models the interrelationship between ordered points on the query shape contour. The masked multi-head self-attention mechanism may be configured to capture spatial relationships, including distances and orientations, between points on the shape. This mechanism may enable the transformer decoder 110 to understand the geometric structure of the shape by processing the sequence of ordered points in a causal manner.

In some cases, the shape contour may be decoded sequentially, where the decoding of point pᵢ=(xᵢ, yᵢ) occurs after point pᵢ₋₁=(xᵢ₋₁, yᵢ₋₁). The decoding of each point pᵢ may depend on the decoding outputs of all previously decoded points (x₀, y₀), . . . , (xᵢ₋₁, yᵢ₋₁). This sequential dependency may allow the system 100 to maintain consistency along the shape contour and ensure that each predicted point location takes into account the positions of preceding points.

In some embodiments, the transformer decoder 110 may include a cross-attention mechanism, also referred to as encoder-decoder attention, in addition to the masked multi-head self-attention mechanism. The cross-attention mechanism may enable the decoder to attend to the encoded features from both the first image 102 and the second image 104 that were processed by the transformer encoder 108. This cross-attention may model the cross-correlation between the two images, allowing the decoder to identify corresponding regions and features across the image pair.

The cross-attention mechanism may operate by using the query representations from the decoder as queries, and the encoded features from the transformer encoder 108 as keys and values. This may allow each point in the query shape to attend to relevant features in both input images, facilitating the identification of the corresponding location in the second image 104. The combination of masked self-attention and cross-attention may enable the transformer decoder 110 to simultaneously maintain geometric consistency along the shape contour while leveraging visual information from both images.

In some embodiments, the sequence of query points may be updated and refined iteratively through multiple layers of the transformer decoder 110. Each decoder layer may progressively improve the representation of the query shape and its correspondence in the second image 104. The iterative refinement through multiple decoder layers may allow the system 100 to gradually incorporate both local geometric constraints from the shape structure and global visual context from the images, resulting in increasingly accurate correspondence estimates as the representations pass through successive decoder layers.

In certain embodiments, the system may further include a recursive zoom-in module that iteratively refines the estimated corresponding line segments in the test image by zooming into regions around initial estimates. This recursive refinement process can achieve sub-pixel accuracy in line segment matching, providing a significant improvement over traditional methods.

The system and methods disclosed herein offer a novel approach to line segment matching that can handle textureless regions, repetitive patterns, and large changes in viewpoint or imaging conditions, which are common challenges in traditional “detect-describe-match” approaches. Furthermore, the system can be trained using a data generation process that adapts based on training loss curves, allowing for continuous improvement and adaptation to various imaging conditions and scenarios.

In some embodiments, the system 100 may achieve line segment and shape matching without relying on traditional computer vision techniques or complex pre-processing and post-processing steps. The system 100 may not require conventional CNN layers beyond the initial feature extraction backbone, edge detection algorithms, descriptor computation, nearest neighbor matching, geometric verification, or RANSAC-based outlier rejection. The transformer-based architecture may directly learn to establish correspondences from the training data, implicitly encoding geometric constraints and visual similarity measures within the learned network parameters. This approach may provide a simpler and more unified framework compared to traditional multi-stage pipelines, while potentially achieving superior performance through end-to-end optimization.

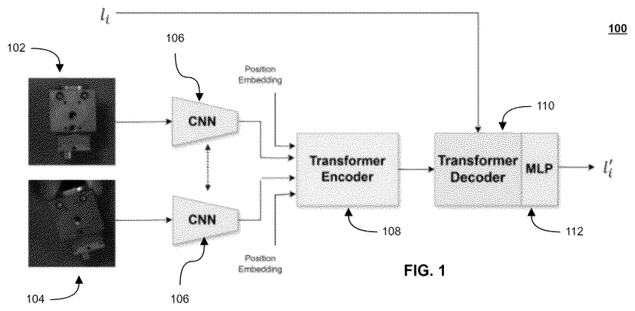

Referring to FIG. 1, the line matching system 100 is shown. The line matching system 100 includes a transformer-based neural network that processes input images and a query line segment to estimate corresponding line segments. The transformer-based neural network includes an encoder, specifically a transformer encoder 108, and a decoder, specifically a transformer decoder 110. The transformer encoder 108 processes feature maps of input images, shown in FIG. 1 as a first image 102 and a second image 104. although any number of images may be used. The transformer decoder 110 processes a query line segment from the first image 102.

In some aspects, the line matching system 100 may include a convolutional neural network backbone 106 for extracting features from the input images. The convolutional neural network backbone 106 may be a pretrained vision transformer, which provides a robust and efficient feature extraction mechanism.

In some embodiments, the convolutional neural network backbone 106 may be a shared CNN backbone that processes both the first image 102 and second image 104 using shared weights. This weight-sharing approach may provide consistent feature extraction across both images, ensuring that similar visual patterns in the reference and test images are encoded in a comparable manner. The shared backbone may reduce the total number of parameters in the system 100 and may improve the network's ability to establish correspondences by ensuring that features from both images are represented in a common feature space.

In some embodiments, the query line segment or query shape may be represented by a sequence of ordered points that are distributed along the shape contour according to various distribution strategies. The points may be evenly distributed along the shape, providing uniform sampling of the contour. Alternatively, the points may be unevenly distributed, with more points positioned around edge points having high curvatures and fewer points positioned on straight line segments. This adaptive point distribution strategy may allow the system 100 to capture fine geometric details in regions of high curvature while maintaining computational efficiency in regions with low geometric complexity.

In some cases, the number of points N used to represent the shape may be selected based on the complexity of the shape geometry, the desired accuracy level, and computational constraints. For example, a shape with multiple sharp corners may be represented with a higher density of points around those corners, while a shape with predominantly straight edges may use fewer points overall.

The line matching system 100 also includes a parallel decoding module, which may be a multilayer perceptron 112. The multilayer perceptron 112 estimates corresponding line segments in the second image 104 based on the processed feature maps and the query line segment from the first image 102. In some cases, the multilayer perceptron 112 may comprise multiple decoder layers that process the query line segment in parallel.

In some embodiments, the line matching system 100 may further include a recursive zoom-in module. This module iteratively refines the estimated corresponding line segments in the second image 104 by zooming into regions around initial estimates. This recursive refinement process can achieve sub-pixel accuracy in line segment matching, providing a significant improvement over traditional methods.

In some embodiments, the line matching system 100 may be configured to match various types of geometric shapes beyond simple line segments. The query shape may comprise an open contour or a closed contour. The query shape may include concave boundaries, convex boundaries, or combinations thereof. In some cases, the query shape may be located on an edge or boundary of an object in the first image 102. In other cases, the query shape may be located in a uniform textureless region where traditional feature-based matching methods may struggle.

The system 100 may be configured to match general geometrical primitives including circles, curves, rectangles, polygons, and arbitrary freeform shapes. In some aspects, even a line segment may be represented as a general shape by interpolating N ordered points between the two endpoints of the line segment. This unified representation framework may allow the system 100 to handle diverse shape matching tasks using a consistent architecture and methodology.

In some cases, the transformer-based neural network of the line matching system 100 may be trained using a data generation process that adapts based on training loss curves. This allows for continuous improvement and adaptation to various imaging conditions and scenarios.

In some embodiments, the line matching system 100 may include specialized processing for detecting and matching circular shapes. As a special case, a circle may be represented using its center coordinates and radius, defined as Pᵢ=(x_{c}, y_{c}, r), where (x_{c}, y_{c}) represents the center location and r represents the radius. This parametric representation may provide a more compact and geometrically meaningful encoding for circular shapes compared to representing the circle as a sequence of ordered points along its perimeter. The transformer-based neural network may be configured to process either the parametric representation or the point-sequence representation depending on the shape type and application requirements.

In some embodiments, the line matching system 100 may include a specialized Vision Transformer (ViT) architecture specifically configured for circle detection and matching. The ViT circle matching module may process cropped image patches containing circular features, where each cropped patch may be combined with position embeddings to provide spatial context. The position-embedded image patches may be fed into a plain Vision Transformer encoder, which may be available in small or tiny configurations to optimize computational efficiency while maintaining detection accuracy.

The ViT circle matching architecture may directly output circle parameters as a coordinate tuple (x, y, r), where x and y represent the center coordinates of the detected circle and r represents the radius. This parametric output may provide a more compact and geometrically meaningful representation compared to representing circles as sequences of ordered points along the circumference. The specialized ViT architecture may enable the system 100 to achieve highly accurate circle detection and matching in industrial inspection applications where circular features such as holes, bores, and apertures are common.

In some embodiments, the system 100 may include geometric calculation capabilities for determining arc length from chord and sagitta measurements. The arc length L may be calculated using the mathematical relationship:

$$L = \frac{π ( {x}^{2} + {y}^{2} ) \cdot arcsin ( \frac{2 x y}{{x}^{2} + {y}^{2}} )}{180 y}$$

where x represents half the chord length, y represents the arc height (sagitta), and L represents the calculated arc length. This geometric relationship may enable the system 100 to characterize circular arcs and partial circles based on measurable chord and sagitta parameters, providing an alternative parameterization method for arc-shaped geometric features.

The chord and sagitta parameterization may be particularly useful for detecting and matching partial circular features or arc segments where the full circle is not visible in the image. The system 100 may use this mathematical relationship to convert between different representations of circular geometry, enabling flexible matching of both complete circles and arc segments across images.

In some embodiments, the system 100 may support multiple parameterization methods for circular and arc-shaped features. Complete circles may be characterized by their center coordinates (x_{c}, y_{c}) and radius r, providing a three-parameter representation that fully defines the circular geometry. Arc segments may be characterized by chord length and sagitta measurements, where the chord length represents the straight-line distance between the arc endpoints and the sagitta represents the perpendicular distance from the chord midpoint to the arc.

The system 100 may automatically determine the most appropriate parameterization method based on the detected geometric feature. For complete or nearly complete circular features, the center-radius parameterization may provide optimal accuracy and computational efficiency. For partial arcs or circular segments, the chord-sagitta parameterization may enable accurate characterization even when the circle center is not visible within the image boundaries. This flexible parameterization approach may enhance the system's ability to handle diverse circular and arc-shaped features in industrial inspection scenarios.

In some embodiments, the system 100 may be configured to simultaneously detect and match multiple types of geometric primitives within the same image or image region. The system 100 may identify circular features alongside polygonal shapes, enabling comprehensive geometric analysis of complex industrial components. For example, the system 100 may detect circular holes or apertures while simultaneously identifying rectangular mounting features, angular brackets, or other polygonal elements within the same component.

The multi-primitive detection capability may involve processing the same image regions through different specialized detection modules, where circular features are processed through the ViT circle matching architecture while polygonal features are processed through the general shape matching pipeline. The system 100 may coordinate the outputs from multiple detection modules to provide a comprehensive geometric description of the analyzed component, facilitating complex inspection and measurement tasks that require analysis of multiple geometric feature types.

In some embodiments, the system 100 may be specifically configured for industrial circle detection applications including the identification and measurement of circular holes, apertures, bores, and eyelet structures in manufactured components. The system 100 may process images of metallic components, stamped parts, machined brackets, and similar industrial items where circular features serve functional purposes such as mounting points, bearing surfaces, or fluid passages.

The industrial circle detection capabilities may include sub-pixel accuracy visualization through the placement of ordered marker points around detected circular boundaries. These marker points may be distributed evenly or adaptively around the circular perimeter, providing visual confirmation of the detection accuracy and enabling precise measurement of circular feature dimensions. The system 100 may handle challenging imaging conditions common in industrial environments, including varying surface reflectivity, subtle texture variations, and complex lighting conditions that can affect the appearance of circular features.

In some embodiments, the system 100 may include a specialized arc refinement process for improving the accuracy of circular arc detection and matching. The arc refinement process may iteratively improve arc detection results by applying geometric constraints derived from the chord-sagitta relationships and the underlying circular geometry. The refinement process may begin with an initial arc detection and progressively refine the arc parameters through multiple iterations until a predetermined accuracy threshold is achieved.

The arc refinement methodology may be particularly beneficial for detecting partial circular features where only a portion of the circle is visible in the image. The refinement process may use the geometric relationships between radius, chord length, sagitta, and central angle to constrain the arc fitting process and improve the robustness of arc detection in challenging imaging conditions. This specialized refinement approach may complement the general recursive zoom-in refinement process described elsewhere, providing targeted optimization for circular and arc-shaped geometric features.

In some aspects, the method for achieving sub-pixel accuracy in line segment matching between images may involve obtaining an initial coarse estimate of a corresponding line segment in the second image 104 for a query line segment in the first image 102 using the transformer-based neural network. This initial coarse estimate may be obtained by processing feature maps of the first and second images 102, 104 using the transformer encoder 108 and processing the query line segment using the transformer decoder 110.

In some cases, the method may further involve recursively zooming into a region around the initial estimate in both images 102, 104. This recursive zooming may involve cropping regions around the initial estimate in both images and resizing the cropped regions to match input dimensions of the transformer-based neural network. This process allows the system 100 to focus on the area of interest and refine the corresponding line segment estimate using the transformer-based neural network on the zoomed-in regions.

In some embodiments, the recursive zooming process may continue until a predetermined accuracy threshold is reached. For example, the predetermined accuracy threshold may be less than one pixel, allowing for highly accurate line segment matching. This iterative refinement and zooming process enables the line matching system 100 to achieve sub-pixel accuracy in line segment matching, providing a significant improvement over traditional methods.

In some embodiments, the recursive zoom-in module may estimate an initial homography transformation using the coarse correspondences obtained from the initial estimate. The homography may represent the geometric transformation between the first image 102 and the second image 104 in the region around the query shape. The system 100 may use the estimated homography to warp and align the images before cropping the regions of interest.

The homography estimation may be performed by computing the transformation matrix that best maps the initial coarse estimate of the corresponding shape points in the second image 104 to the query shape points in the first image 102. Once the homography is estimated, the system 100 may apply the transformation to warp a local patch around the corresponding shape in the second image 104, aligning it with the reference patch in the first image 102. The warped and aligned patches may then be used as inputs to the transformer-based neural network for refined shape correspondence estimation.

Referring to FIG. 1, the line matching system 100 may further include a recursive zoom-in module. This module iteratively refines the estimated corresponding line segments in the second image 104 by zooming into regions around initial estimates. This recursive refinement process can achieve sub-pixel accuracy in line segment matching, providing a significant improvement over traditional methods.

In some aspects, the recursive zooming process may involve cropping regions around the initial estimate in both images 102, 104. This cropping process may be performed by a cropping module (not shown in FIG. 1) that is configured to identify a region of interest around the initial estimate in each image. The region of interest may be defined based on the location and orientation of the initial estimate and may be of a predetermined size that is sufficient to include the corresponding line segment in the second image 104.

Once the regions of interest have been cropped from the first and second images 102, 104, these cropped regions may be resized to match the input dimensions of the transformer-based neural network. This resizing process may be performed by a resizing module (not shown in FIG. 1) that is configured to adjust the size of the cropped regions while maintaining the aspect ratio of the original images. The resized cropped regions may then be used as input to the transformer-based neural network for further processing.

In some cases, the recursive zooming process may continue until a predetermined accuracy threshold is reached. For example, the predetermined accuracy threshold may be less than one pixel, allowing for highly accurate line segment matching. This iterative refinement and zooming process enables the line matching system 100 to achieve sub-pixel accuracy in line segment matching, providing a significant improvement over traditional methods.

In some embodiments, when the query shape is significantly larger than the input dimensions of the transformer-based neural network (for example, much larger than 256×256 pixels), the system 100 may dissect the shape into multiple sub-shapes for individual processing. Each sub-shape may be fine-aligned individually using the recursive zoom-in process described above. After obtaining refined correspondences for each sub-shape, the system 100 may combine the individually aligned sub-shapes to reconstruct the complete corresponding shape in the second image 104.

This shape dissection approach may enable the system 100 to achieve sub-pixel accuracy for large and complex shapes that would otherwise exceed the resolution capabilities of the transformer-based neural network. The dissection may be performed by dividing the shape into overlapping or non-overlapping segments, processing each segment independently, and then merging the results using continuity constraints to ensure smooth transitions between adjacent segments.

In some embodiments, the line matching system 100 may apply the correspondence network at inference time by recursively zooming in around the estimates. This process may involve repeatedly applying the transformer-based neural network to the zoomed-in regions until the estimated corresponding line segments in the second image 104 meet the predetermined accuracy threshold. This recursive application of the correspondence network allows the line matching system 100 to refine the estimated corresponding line segments in a step-by-step manner, gradually improving the accuracy of the line segment matching.

In some cases, the predetermined accuracy threshold may be set to achieve specific levels of precision such as 1/10^{th} pixel accuracy or 1/100^{th} pixel accuracy. The number of recursive zoom-in iterations may be determined based on the target accuracy level. For example, achieving 1/10^{th} pixel accuracy may require one or two zoom-in iterations, while achieving 1/100^{th} pixel accuracy may require three or more zoom-in iterations. Each zoom-in iteration may improve the localization precision by approximately one order of magnitude, allowing the system 100 to progressively refine the shape correspondence to the desired accuracy level.

In some embodiments, the application of transformer attention mechanisms to vision problems may involve a trade-off between computational efficiency and localization precision. The transformer architecture may require heavily downsampled feature maps, such as feature maps downsampled to 256×256 spatial resolution, to maintain computational tractability. This downsampling may naturally result in poorly localized correspondence estimates at the initial coarse matching stage. The recursive zoom-in module may address this resolution problem by exploiting the functional nature of the correspondence estimation, applying the transformer-based neural network recursively to progressively zoomed-in image regions. This multi-scale approach may enable the system 100 to benefit from the global context modeling capabilities of transformers while achieving sub-pixel localization accuracy through iterative refinement.

In some embodiments, the system 100 may exploit the functional nature of the correspondence estimation approach by treating the transformer-based neural network as a function that can be applied recursively at different scales. Rather than training separate networks for different resolution levels, the same transformer-based neural network may be applied multiple times to increasingly refined image regions. This functional approach may enable the system 100 to leverage the same learned correspondence estimation capabilities across multiple scales, providing a unified framework for both coarse and fine matching without requiring scale-specific model components.

Still referring to FIG. 1, the line matching system 100 may be trained using a data generation process that adapts based on training loss curves. In some aspects, the training process may involve generating training data samples of image pairs with annotated line segment correspondences. These samples may be generated by applying random geometric transformations to a set of base images and annotating line segment correspondences between the original and transformed images. The random geometric transformations may include at least one of rotation, scaling, perspective change, and affine transformation.

The generated training data samples may then be used to train the transformer-based neural network of the line matching system 100. The training process may involve processing feature maps of the first and second images 102, 104 using the transformer encoder 108 and processing the query line segment using the transformer decoder 110. The training process may also involve analyzing training loss curves to monitor the convergence rates of different types of training samples and identify types of samples that contribute most to reducing overall loss.

In some embodiments, the training process may employ an online data synthesizing methodology capable of generating unlimited pairs of images with annotated shape correspondences. The synthetic image pairs may be generated by taking images of the same scene or object under different viewing angles, applying geometrical homography transformations, and subjecting the images to varying image conditions such as different lighting, noise levels, blur, and contrast variations. This unlimited data generation capability may enable the transformer-based neural network to be trained on a highly diverse dataset that covers a wide range of geometric transformations and imaging conditions, allowing the trained model to generalize effectively to real-world samples in various environments.

In some cases, the difficulty and types of subsequently generated training samples may be adaptively adjusted based on the analyzed loss curves. For example, the proportion of sample types that contribute most to reducing overall loss may be increased, and the difficulty of the geometric transformations applied to generate new samples may be gradually increased. This adaptive adjustment of the training data generation process allows the line matching system 100 to continuously improve and adapt to various imaging conditions and scenarios.

In some embodiments, the trained transformer-based neural network of the line matching system 100 may be fine-tuned on a specific dataset of line segment correspondences to adapt the model for a particular application domain. This fine-tuning process may involve further training the transformer-based neural network using the specific dataset, which may include image pairs with annotated line segment correspondences that are representative of the particular application domain.

In some embodiments, the line matching system 100 may generate samples for warming up the network in the early stage of training. These samples may involve simple transformations and clear line segment correspondences, allowing the network to learn basic patterns and relationships. As the training progresses, the system 100 may increase the level of difficulty and types of data samples along the training. This may involve introducing more complex scenarios and challenging imaging conditions, pushing the network to learn more advanced patterns and adapt to a wider range of scenarios.

The training loss curves may be analyzed online during the training process. This analysis may involve monitoring the convergence rates of different types of training samples and identifying types of samples that contribute most to reducing overall loss. Based on this analysis, the difficulty and types of subsequently generated training samples may be adaptively adjusted. For example, if the training loss for a certain type of sample is found to be decreasing slowly, the system 100 may increase the proportion of that type of sample in the subsequent training data. Similarly, if a certain type of scenario is found to be particularly challenging for the network, the system 100 may increase the difficulty of that scenario in the subsequent training data. This adaptive adjustment of the training data generation process allows the line matching system 100 to continuously improve and adapt to various imaging conditions and scenarios.

In some embodiments, the analysis of training loss curves may be performed online during the training process in real-time. The system may continuously monitor the training loss and validation loss as the transformer-based neural network processes batches of training samples. The online analysis may identify which types of training samples are contributing most effectively to reducing the overall loss and which types of samples represent challenging scenarios where the network's performance is improving slowly.

Based on the real-time analysis, the adaptive adjustment may dynamically modify the data generation parameters during the training process without interrupting the training. For example, if the analysis indicates that samples with large perspective transformations are causing slow convergence, the system may temporarily increase the proportion of such samples in subsequent batches to focus the network's learning on these challenging cases. Conversely, if certain types of samples are being learned effectively, the system may reduce their proportion and introduce more diverse or difficult sample types.

This online adaptive training approach may allow the training process to be self-optimizing, automatically adjusting the training data distribution to maximize learning efficiency and ensure that the trained network can handle a wide range of imaging conditions and geometric transformations.

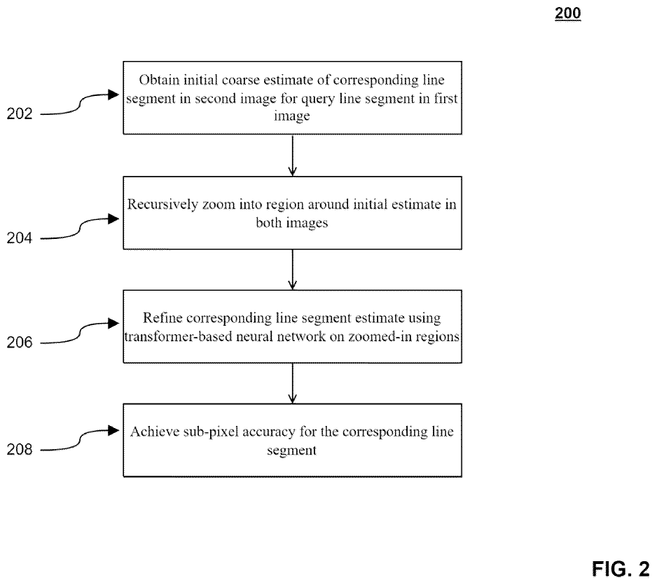

Referring now to FIG. 2, a flowchart illustrating a method 200 for achieving sub-pixel accuracy in line segment matching between images is shown. The method 200 may be implemented using the line matching system 100 described in FIG. 1, although other suitable systems may also be used.

The method 200 begins with step 202, where an initial coarse estimate of a corresponding line segment in a second image is obtained for a query line segment in a first image using a transformer-based neural network. In some aspects, this step may involve processing feature maps of the first and second images using the transformer encoder 108 and processing the query line segment using the transformer decoder 110. The initial coarse estimate may provide a starting point for further refinement.

Following the initial estimate, the method 200 proceeds to step 204, where the process recursively zooms into a region around the initial estimate in both the first and second images. This zooming action may involve cropping regions around the initial estimate in both images and resizing the cropped regions to match input dimensions of the transformer-based neural network. The zooming process allows for a more detailed examination of the area of interest, potentially revealing finer details that may have been obscured in the full-scale images.

In step 206, the method 200 refines the corresponding line segment estimate using the transformer-based neural network on the zoomed-in regions. This refinement process may leverage the more detailed information available in the zoomed-in areas to improve the accuracy of the line segment match. The transformer-based neural network may be applied to the zoomed-in regions in a manner similar to the initial estimation, but with the benefit of increased resolution and focus on the relevant image areas.

The final step in the method 200 is step 208, where sub-pixel accuracy is achieved for the corresponding line segment. This high level of precision may be made possible by the recursive zooming and refinement process in the previous steps. Sub-pixel accuracy refers to the ability to estimate the position of the corresponding line segment with a precision finer than the resolution of individual pixels in the original images.

In some implementations, the method 200 may iterate through steps 204, 206, and 208 multiple times, each time zooming in further and refining the estimate until a predetermined accuracy threshold is reached. This threshold may be set to less than one pixel, ensuring highly accurate line segment matching.

The method 200 may be particularly effective in scenarios where traditional line segment matching techniques struggle, such as in the presence of textureless regions, repetitive patterns, or large changes in viewpoint or imaging conditions. By combining the global context-aware capabilities of the transformer-based neural network with the recursive zooming approach, the method 200 may achieve robust and precise line segment matching across a wide range of image types and conditions.

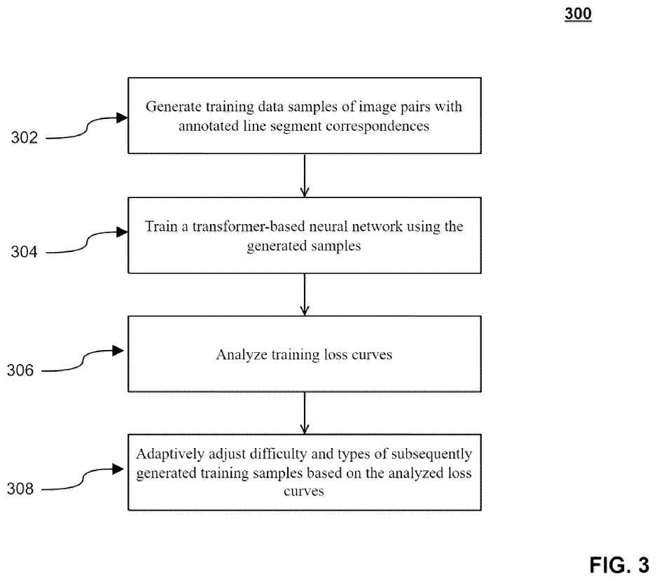

Referring now to FIG. 3, a flowchart illustrating a method 300 for training a line segment matching model is shown. The method 300 may be implemented to train the transformer-based neural network used in the line matching system 100 described in FIG. 1, although it may also be applied to train other suitable models for line segment matching.

The method 300 begins with step 302, where training data samples of image pairs with annotated line segment correspondences are generated. The line segment correspondences between the images are then annotated, creating a diverse dataset for training the model.

In some embodiments, the generation of training data samples may include a warm-up phase during the early stages of training. During the warm-up phase, the system may generate training samples with simple geometric transformations and clear, unambiguous line segment or shape correspondences. These warm-up samples may allow the transformer-based neural network to learn basic patterns and relationships before being exposed to more challenging scenarios.

As the training progresses beyond the warm-up phase, the system may gradually increase the complexity and difficulty of the generated training samples. The increased difficulty may involve introducing larger geometric transformations, more cluttered backgrounds, greater variations in illumination and imaging conditions, and shapes located in textureless regions. This gradual progression from simple to complex training samples may improve the stability and convergence of the training process while ensuring that the final trained network is robust to challenging real-world conditions.

Following the data generation, the method 300 proceeds to step 304, where a transformer-based neural network is trained using the generated samples. This training process may involve feeding the generated image pairs through the network, comparing the network's predictions with the annotated line segment correspondences, and adjusting the network's parameters to minimize the prediction error. The training may utilize techniques such as backpropagation and gradient descent to optimize the network's performance.

In step 306, the method 300 analyzes training loss curves. This analysis may involve monitoring the convergence rates of different types of training samples and identifying which types of samples contribute most to reducing the overall loss. The loss curves may provide insights into how well the model is learning and whether it is overfitting or underfitting the training data.

The final step in the method 300 is step 308, where the difficulty and types of subsequently generated training samples are adaptively adjusted based on the analyzed loss curves. In some implementations, this step may involve increasing the proportion of sample types that contribute most to reducing overall loss. This adaptive adjustment allows the training process to focus on challenging cases and continuously push the model's capabilities.

In some aspects, the method 300 may be implemented as an iterative process, with steps 302 through 308 repeated multiple times. Each iteration may refine the training data generation process and improve the model's performance. The number of iterations may be predetermined or may continue until a certain performance threshold is reached.

The method 300 may also incorporate techniques to prevent overfitting. For example, a validation dataset may be used to monitor the model's performance on unseen data throughout the training process. If the model's performance on the validation set begins to degrade while its performance on the training set continues to improve, this may indicate overfitting, and the training process may be adjusted accordingly.

In some implementations, the method 300 may include a fine-tuning phase after the initial training. This fine-tuning may involve training the model on a specific dataset of line segment correspondences relevant to a particular application domain. This allows the model to be adapted for specific use cases while leveraging the general knowledge gained from the initial training process.

The adaptive nature of the method 300 allows it to efficiently train a line segment matching model that can handle a wide range of imaging conditions and scenarios. By continuously adjusting the training process based on the model's performance, the method 300 may produce a robust and accurate line segment matching model suitable for various computer vision applications.

In some embodiments, the line matching system 100 may be trained using a data generation process that adaptively adjusts the difficulty and types of subsequently generated training samples based on the analyzed loss curves. This adaptive adjustment allows the line matching system 100 to continuously improve and adapt to various imaging conditions and scenarios.

In some cases, the adaptive adjustment of the difficulty and types of subsequently generated training samples may involve increasing the proportion of sample types that contribute most to reducing overall loss. For example, if the training loss for a certain type of sample is found to be decreasing slowly, the system 100 may increase the proportion of that type of sample in the subsequent training data. This approach allows the line matching system 100 to focus on the types of samples that are most challenging for the network, thereby improving the network's ability to handle these challenging samples.

In addition to adjusting the proportion of sample types, the adaptive adjustment may also involve gradually increasing the difficulty of the geometric transformations applied to generate new samples. For instance, if a certain type of transformation is found to be particularly challenging for the network, the system 100 may increase the difficulty of that transformation in the subsequent training data. This approach allows the line matching system 100 to gradually expose the network to more complex transformations, thereby improving the network's ability to handle these complex transformations.

In some aspects, the adaptive adjustment of the difficulty and types of subsequently generated training samples may be performed in an online manner during the training process. This online adjustment allows the line matching system 100 to continuously monitor the training loss curves and adjust the training data generation process in real-time based on the analyzed loss curves. This real-time adjustment enables the line matching system 100 to quickly respond to changes in the training loss curves and continuously improve the network's performance.

In some embodiments, the line matching system 100 may incorporate the training data generation process in the training loop, allowing the data generation to adapt itself to the training loss curves. This integrated approach allows the line matching system 100 to closely align the data generation process with the training process, thereby improving the efficiency and effectiveness of the training process.

Architectural Distinction from Line Matching

In some embodiments, the line matching system 100 may be configured specifically for general shape matching as distinguished from simpler line segment matching. This architectural distinction represents a fundamental difference in the complexity of geometric primitives being processed and the corresponding computational requirements. For line segment matching, where the geometric primitive consists of only two endpoints defined as lᵢ={(x₁,y₁), (x₂,y₂)}, a transformer decoder without masked multi-head self-attention may be sufficient since the relationship between only two points can be adequately captured through simpler attention mechanisms. The limited number of points in a line segment reduces the complexity of spatial relationships that need to be modeled, allowing for more straightforward correspondence estimation.

However, for general shape matching involving sequences of multiple ordered points along complex contours, where shapes are represented as [symbol] ᵢ={(x₀,y₀), (x₁,y₁), (x₂,y₂), . . . , (x_{N-1},y_{N-1})} with N potentially being much larger than 2, the inclusion of masked multi-head self-attention in the transformer decoder 110 may be necessary to capture the interrelationships between points and maintain structural awareness of the shape geometry. The masked attention mechanism ensures that when decoding point pᵢ=(xᵢ, yᵢ), the system can only attend to previously decoded points {(x₀,y₀), (x₁,y₁), . . . , (xᵢ₋₁,yᵢ₋₁)}, maintaining the causal nature of the sequential decoding process while preventing the decoder from accessing future points in the sequence.

The masked multi-head self-attention mechanism may enable the transformer decoder 110 to model dependencies between sequential points along the shape contour, understanding how each point relates to its neighbors and to the overall shape structure. This mechanism may compute attention weights that reflect the spatial relationships, distances, and orientations between points on the shape contour, allowing the system to understand not only the local neighborhood of each point but also its role within the broader geometric context of the entire shape. The multi-head aspect of the attention mechanism may allow the system to simultaneously attend to different types of relationships, such as local curvature patterns, global shape symmetries, and structural regularities that span multiple points along the contour.

This structural awareness may be particularly important for matching shapes with high curvature variations, complex geometries, n-gons, or shapes that lack distinctive local texture features. In industrial machine vision applications, shapes may be located in uniform textureless regions where traditional feature-based matching methods struggle, making the geometric relationships between points the primary source of discriminative information. The system 100 may leverage the attention mechanism to identify characteristic patterns in the point sequence, such as sharp corners, smooth curves, or periodic structures, that can serve as distinctive signatures for shape matching even in the absence of strong local image features.

By processing the ordered point sequence in a causal manner through masked self-attention, the system 100 may ensure geometric consistency and smoothness in the predicted corresponding shape. The causal processing ensures that each predicted point location takes into account the positions and relationships of all previously predicted points, maintaining continuity along the shape contour and preventing geometric inconsistencies that could arise from independent point predictions. This sequential dependency may be particularly valuable for maintaining the topological properties of the shape, ensuring that the predicted corresponding shape preserves important geometric characteristics such as convexity, closure, and relative point spacing that define the shape's identity across different images and viewing conditions.

### Token-Based Shape Representation

In some embodiments, the representation of shapes as sequences of ordered points may be analogous to token-based representations used in natural language processing. Each point along the shape contour may be treated as a token, similar to how words are treated as tokens in language models. The sequence of points (tokens) may be processed by the transformer-based neural network in a manner similar to how large language models process sequences of words. This analogy extends to the fundamental processing paradigm where each coordinate pair (xᵢ, yᵢ) functions as a discrete semantic unit that carries both spatial information and contextual meaning within the broader shape structure.

This token-based representation may allow the transformer architecture to leverage its attention mechanisms to understand relationships between points along the shape, similar to how language models understand relationships between words in a sentence. The positional encoding associated with each point token may provide the network with information about the point's location along the shape contour, enabling the network to distinguish between points based on both their spatial coordinates and their sequential position within the shape definition. The attention mechanism may compute relationships between point tokens that capture geometric properties such as local curvature, directional changes, and structural patterns that define the shape's characteristic features.

The transformer decoder 110 may process these point tokens sequentially, where each point token attends to previously processed tokens in the sequence, creating a causal dependency structure that mirrors the sequential nature of language generation. This sequential processing may enable the system 100 to maintain geometric consistency along the shape contour, ensuring that each predicted point location is informed by the spatial relationships and geometric constraints established by preceding points. The masked multi-head self-attention mechanism may allow the network to simultaneously model multiple types of geometric relationships, such as local neighborhood connectivity, global shape symmetries, and structural regularities that span multiple points along the contour.

The vocabulary of this geometric language may consist of the continuous coordinate space, where each point token represents a specific location within the image coordinate system. Unlike discrete word vocabularies in natural language processing, the geometric vocabulary may be continuous and unbounded, requiring the network to learn smooth interpolation and extrapolation capabilities across the coordinate space. The transformer architecture may learn to encode geometric primitives and shape patterns as recurring motifs in the point sequence, similar to how language models learn to recognize syntactic structures and semantic patterns in text sequences.

### Encoder-Decoder Architecture Selection

In some embodiments, the choice of an encoder-decoder transformer architecture for the system 100 may be motivated by the specific requirements of the shape correspondence task. Encoder-only transformer models may be unsuitable because they can only map an input sequence to an output sequence of a priori known output length, and their output dimension does not depend on the input sequence, making them disadvantageous for sequence-to-sequence tasks like shape matching. Decoder-only transformer models may function for sequence-to-sequence tasks but may have limitations due to unidirectional self-attention, which forces the model's representation of the input sequence to be unnecessarily limited since each element cannot depend on subsequent elements.

The encoder-decoder architecture may provide an ideal solution for the shape correspondence task, which can be formulated as a sequence-to-sequence problem where a sequence of query shape points in the reference image is mapped to a sequence of corresponding points in the test image. The encoder may process both input images bidirectionally to create rich contextual representations, while the decoder may generate the output sequence autoregressively, attending to both the encoded input representations and previously generated outputs. This architecture may enable the system 100 to effectively model complex mappings from query shapes to their correspondences across images.

In some embodiments, the transformer-based neural network may be initialized using warm-started models with pre-trained encoder and/or decoder-only checkpoints to reduce training costs. For example, the encoder may be initialized with weights from pre-trained models such as BERT, while the decoder may be initialized with weights from models such as GPT-2. This warm-starting approach may allow the system 100 to skip costly pretraining from scratch while achieving competitive results compared to fully pretrained encoder-decoder models. The warm-started models may be fine-tuned on shape correspondence datasets, allowing the network to adapt the general language understanding or vision capabilities encoded in the pretrained weights to the specific task of geometric shape matching. This approach may significantly reduce the computational resources and training time required to develop an effective shape matching system.

In some embodiments, the operation of the encoder-decoder architecture during inference may involve different numbers of forward passes for the encoder and decoder components. The transformer encoder 108 may be used only in the first forward pass to encode the feature maps from the first image 102 and second image 104 into contextualized representations. The decoder may then use the previously calculated encoding from the encoder along with previously decoded shape points to decode subsequent points in the sequence. The number of decoder forward passes may be equal to the number of points in the query shape sequence, as each point may be decoded sequentially in a causal manner. This asymmetric processing, where the encoder processes both images once and the decoder iteratively generates the output sequence, may provide computational efficiency while enabling the sequential generation of geometrically consistent shape correspondences.

### INDUSTRIAL APPLICATIONS AND USE CASES

In some embodiments, the line matching system 100 may be particularly suited for industrial machine vision applications including gauging, alignment, and inspection tasks. The system 100 may be deployed in automated manufacturing environments where precise measurement and pose estimation of industrial parts are required. The system 100 may handle geometric transformations via homographies, which commonly occur in industrial part inspection scenarios where parts are viewed from different angles or positions.

The system 100 may be configured to operate effectively in challenging industrial imaging conditions including different imaging modalities, cluttered backgrounds with multiple objects, and scenes with weak textures or uniform surfaces. These capabilities may make the system 100 suitable for applications such as robotic navigation, fixture alignment, quality control inspection, and automated assembly verification. In some cases, the system 100 may represent an extension of line finding algorithms to enable matching of general geometric shapes, providing customers with enhanced flexibility for defining and matching arbitrary shape templates in their inspection and measurement applications.

In some embodiments, the system 100 may be designed with emphasis on speed and computational efficiency to enable deployment on energy-constrained devices. While pursuing performance that exceeds conventional rule-based or deep learning-based shape matching systems, the system 100 may be optimized to operate within the computational and power constraints of embedded vision systems, mobile devices, or edge computing platforms. The system 100 may achieve this efficiency through the use of a compact transformer-based encoder-decoder architecture, efficient feature extraction, and optimized inference procedures. This focus on computational efficiency may make the system 100 suitable for real-time industrial inspection applications where processing must occur on-device without reliance on cloud computing resources.

A number of implementations have been described. Nevertheless, it will be understood that various modifications may be made without departing from the spirit and scope of the disclosure. Accordingly, other implementations are within the scope of the following claims.

1. A system for matching geometric shapes between images, comprising:
a convolutional neural network that extracts feature maps from a reference image and a test image;
a transformer encoder that processes the feature maps from the reference image and the test image to generate encoded features;
a transformer decoder comprising a masked multi-head self-attention mechanism that processes a query shape represented as a sequence of ordered points from the reference image, wherein the masked multi-head self-attention mechanism models interrelationships between the ordered points on the query shape; and
a multilayer perceptron that generates corresponding shape points in the test image based on output from the transformer decoder.

2. The system of claim 1, wherein the query shape comprises a sequence of N ordered point locations represented as coordinate pairs (x₀, y₀), (x₁, y₁), . . . , (xₙ₋₁, yₙ₋₁) in the reference image.

3. The system of claim 2, wherein the ordered points are distributed along a contour of the query shape with more points positioned around edge points having high curvatures and fewer points positioned on straight line segments.

4. The system of claim 1, wherein the transformer decoder processes the sequence of ordered points in a causal manner such that decoding of point pᵢ depends on decoding outputs of all previously decoded points p₀ through pᵢ₋₁.

5. The system of claim 1, further comprising a coarse-to-fine correspondence refinement module that:
estimates an initial homography using coarse correspondences from the transformer decoder;
warps corresponding local patches from the reference image and the test image based on the initial homography; and
applies the transformer encoder and transformer decoder to the warped patches to obtain refined shape correspondence.

6. The system of claim 5, wherein the coarse-to-fine correspondence refinement module iteratively applies the refinement process multiple times to achieve sub-pixel accuracy.

7. The system of claim 1, wherein the query shape comprises one of an open contour, a closed contour, a concave boundary, a convex boundary, an object edge, or a shape located in a uniform textureless region.

8. A method for matching geometric shapes between images, comprising:
extracting feature maps from a reference image and a test image using a convolutional neural network;
processing the feature maps using a transformer encoder to generate encoded features;
processing a query shape represented as a sequence of ordered points from the reference image using a transformer decoder comprising a masked multi-head self-attention mechanism, wherein the masked multi-head self-attention mechanism captures causal dependencies between sequential points along a shape contour; and
generating corresponding shape points in the test image using a multilayer perceptron based on output from the transformer decoder.

9. The method of claim 8, wherein the query shape comprises a sequence of N ordered point locations represented as coordinate pairs (x₀, y₀), (x₁, y₁), . . . , (xₙ₋₁, yₙ₋₁) in the reference image.

10. The method of claim 9, wherein the ordered points are distributed along a contour of the query shape with more points positioned around edge points having high curvatures and fewer points positioned on straight line segments.

11. The method of claim 8, wherein the transformer decoder processes the sequence of ordered points in a causal manner such that decoding of point pᵢ depends on decoding outputs of all previously decoded points p₀ through pᵢ₋₁.

12. The method of claim 8, further comprising a step of performing coarse-to-fine correspondence refinement by:
estimating an initial homography using coarse correspondences from the transformer decoder;
warping corresponding local patches from the reference image and the test image based on the initial homography; and
applying the transformer encoder and transformer decoder to the warped patches to obtain refined shape correspondence.

13. The method of claim 12, further comprising a step of iteratively applying the coarse-to-fine correspondence refinement process multiple times to achieve sub-pixel accuracy.

14. The method of claim 10, wherein the query shape comprises one of an open contour, a closed contour, a concave boundary, a convex boundary, an object edge, or a shape located in a uniform textureless region.

15. A computer-implemented method for achieving sub-pixel accuracy in shape correspondence between images, comprising:
obtaining an initial coarse estimate of a corresponding shape in a test image for a query shape in a reference image using a transformer-based neural network comprising a transformer decoder with masked multi-head self-attention;
estimating an initial homography using the coarse estimate;
warping corresponding local patches from the reference image and test image based on the initial homography; and
applying the transformer-based neural network to the warped patches to obtain a refined shape correspondence with sub-pixel accuracy.

16. The method of claim 15, wherein the query shape comprises a sequence of N ordered point locations represented as coordinate pairs (x₀, y₀), (x₁, y₁), . . . , (xₙ₋₁, yₙ₋₁) in the reference image.

17. The method of claim 16, wherein the ordered points are distributed along a contour of the query shape with more points positioned around edge points having high curvatures and fewer points positioned on straight line segments.

18. The method of claim 15, wherein the step of applying the transformer-based neural network to the warped patches is performed iteratively multiple times to progressively improve the refined shape correspondence.

19. The method of claim 18, wherein the iterative application continues until a predetermined accuracy threshold of less than one pixel is achieved.

20. The method of claim 15, wherein the query shape comprises one of an open contour, a closed contour, a concave boundary, a convex boundary, an object edge, or a shape located in a uniform textureless region.
